(19) United States
(12) Patent Application Publication
(10) Pub. No.: US 2025/0262908 A1
(43) Pub. Date: Aug. 21, 2025

(54) AIR CONDITIONER FOR VEHICLE

(71) Applicant: Hanon Systems, Daejeon (KR)

(72) Inventors: Woo Hyun CHO, Daejeon (KR); Seung Min LEE, Daejeon (KR); Seung Ho LEE, Daejeon (KR); Jae Hyeon LIM, Daejeon (KR); Yong Sik KIM, Daejeon (KR); Jun Chul AN, Daejeon (KR); Sang Ki LEE, Daejeon (KR)

(73) Assignee: Hanon Systems, Daejeon (KR)

(21) Appl. No.: 19/048,720

(22) Filed: Feb. 7, 2025

(30) Foreign Application Priority Data
Feb. 15, 2024 (KR) 10-2024-0022048

(51) Int. Cl. B60H 1/00

(52) U.S. Cl. CPC B60H 1/00692; B60H 2001/00721

(57) ABSTRACT

Disclosed is an air conditioner for a vehicle which has an improved shaft structure to enhance temperature controllability and adjust an air discharge volume, thereby improving airflow distribution. The air conditioner includes: an air conditioning case in which an air passage and a plurality of air discharge ports are formed; a cooling heat exchanger and a heating heat exchanger sequentially arranged in the air passage of the air conditioning case in an air flow direction; and a door adjusting the opening degree of the air discharge ports, wherein the door is formed in a sliding type and includes a shaft, a gear part, and a plate part which engages with the gear part to open and close the air discharge ports, and a guide part guiding the air flow direction is provided on the shaft.

### CROSS REFERENCE TO RELATED APPLICATIONS

The present application claims the benefit of priority to Korean Patent Application No. KR 10-2024-0022048, filed Feb. 15, 2024, and is incorporated herein by reference in its entirety.

### BACKGROUND OF THE PRESENT INVENTION

### Field of the Present Invention

The present invention relates to an air conditioner for a vehicle, and more specifically, to an air conditioner for a vehicle, in which a door for adjusting the opening degree of an air discharge port is formed in a sliding type and has an improved shaft structure.

### Background Art

In general, an air conditioner for a vehicle is a vehicle interior part that is installed for the purpose of cooling or heating the interior of the vehicle in the summer or winter or securing a driver's front and rear view by removing the frost from the windshield during the rainy or winter season. The air conditioner is usually equipped with a heating system and a cooling system to selectively introduce the indoor air or the outdoor air, heat or cool the air, and blow the heated or cooled air to the interior of the vehicle, thereby cooling, heating, or ventilating the interior of the vehicle.

Referring to FIG. 1, a conventional air conditioner 1 for a vehicle includes an air conditioning case 10, an evaporator 20 which is a cooling heat exchanger, an indoor condenser 30 which is a heating heat exchanger, and a temperature door 40. The evaporator 20 and the indoor condenser 30 are sequentially arranged inside the air conditioning case 10 in an air flow direction. Downstream of the indoor condenser 13 in the air flow direction, an electric heater such as a PTC heater can be provided.

The temperature door 40 adjusts the opening degree of a warm air passage 15 passing through the indoor condenser 30 and a cold air passage 14 bypassing the indoor condenser 30, thereby controlling the interior temperature of the vehicle. The air conditioning case 10 includes a plurality of air discharge ports. The air discharge ports include a defrost vent 11, a face vent 12, and a floor vent 13. The defrost vent 11 discharges wind towards the vehicle window, the face vent 12 discharges wind towards passengers' faces, and the floor vent 13 discharges wind towards the passengers' feet.

Additionally, the air conditioning case 10 includes a plurality of doors to control the opening degree of the air discharge ports. That is, the air conditioning case 10 includes a defrost door 51 for controlling the opening degree of the defrost vent 11, a vent door 52 for controlling the opening degree of the face vent 12, and a floor door 53 for controlling the opening degree of the floor vent 13. The temperature door 40 is formed in a sliding type, and has a rail-shaped guide groove 60 formed on the inner wall of the air conditioning case 10 to guide the temperature door 40.

The temperature door 40 has a driven gear 43 that meshes with a driving gear 70. The temperature door 40 slidably moves along the guide groove 60 by the rotation of the driving gear 70. The guide groove 60 extends in a convex arc shape in the wind direction, and the temperature door 40 is correspondingly curved to fit the guide groove 60. The driving gear 70 has a drive shaft 71 extending in the width direction of the door.

When the conventional air conditioner for the vehicle has a door formed in a sliding type, a shaft for actuating the door is located within an air passage toward the discharge port of the face vent 12 or the floor vent 13, obstructing the flow of air. So, cold air or warm air fails to reach a target point intended in a design, and is dispersed. Additionally, the conventional air conditioner for the vehicle has another problem in that a gear part which is a portion of the shaft blocks an air discharge area, causing uneven airflow distribution through the discharge ports.

### SUMMARY OF THE INVENTION

Accordingly, the present invention has been made to solve the above-mentioned problems occurring in the prior arts, and it is an objective of the present invention to provide an air conditioner for a vehicle which has an improved shaft structure to enhance temperature controllability and adjust an air discharge volume, thereby improving airflow distribution.

To accomplish the above object, according to the present invention, there is provided an air conditioner for a vehicle including: an air conditioning case in which an air passage and a plurality of air discharge ports are formed; a cooling heat exchanger and a heating heat exchanger sequentially arranged in the air passage of the air conditioning case in an air flow direction; and a door adjusting the opening degree of the air discharge ports, wherein the door is formed in a sliding type and includes a shaft, a gear part, and a plate part which engages with the gear part to open and close the air discharge ports, and a guide part guiding the air flow direction is provided on the shaft.

The guide part is positioned between the plate part and the shaft or arranged on the opposite side of the plate part depending on the position of the shaft to guide the airflow.

The shaft is placed on one side of the air discharge port.

The guide part includes a baffle which protrudes on the shaft in a radial direction.

The baffle rotates integrally with the shaft as the door moves.

The door includes a vent door which adjusts the opening degree of the face vent, and the baffle is formed on the shaft of the vent door.

The face vent is partitioned into a center vent and a side vent in the vehicle width direction, and the baffle includes a center vent baffle formed at a position corresponding to the center vent and a side vent baffle formed at a position corresponding to the side vent.

The center vent baffle and the side vent baffle are positioned at different locations in the circumferential direction of the shaft.

The center vent baffle and the side vent baffle are positioned 180° apart from each other in the circumferential direction of the shaft, protruding in opposite directions to each other.

The center vent baffle and the side vent baffle are formed only on a portion of an end of the shaft in an axial direction.

The center vent baffle protrudes further in the radial direction of the shaft than the side vent baffle.

The shaft includes a plurality of recessed sliming parts, and the baffle protrudes parallel to the recessed direction of the sliming parts.

The baffle is positioned perpendicular to the air flow direction to suppress the flow of air discharged to the face vent during an air conditioning mode where the vent door opens the face vent.

The protrusion length of the baffle is formed to be smaller than the radius of the gear part of the shaft.

Depending on the air conditioning mode, the center vent baffle or the side vent baffle is positioned to suppress the airflow, selectively reducing the airflow to the center vent or the side vent.

In a vent mode where air is discharged only to the face vent, the center vent baffle is positioned to suppress the airflow.

In a bi-level mode where air is discharged to the face vent and the floor vent, the side vent baffle is positioned to suppress the airflow.

In a floor mode where air is discharged to the floor vent or in a defrost mode where air is discharged to the defrost vent, the center vent baffle and the side vent baffle are positioned parallel to the air flow direction.

The air conditioner for the vehicle according to the present invention can use the disadvantage of the shaft acting as a resistor, achieve a desired airflow by additionally installing a baffle as a resistor onto the shaft, improve the temperature controllability of cold air and warm air, and adjust the discharged airflow to enhance airflow distribution.

### BRIEF DESCRIPTION OF THE DRAWINGS

FIG. 1 is a side sectional view illustrating a conventional air conditioner for a vehicle.

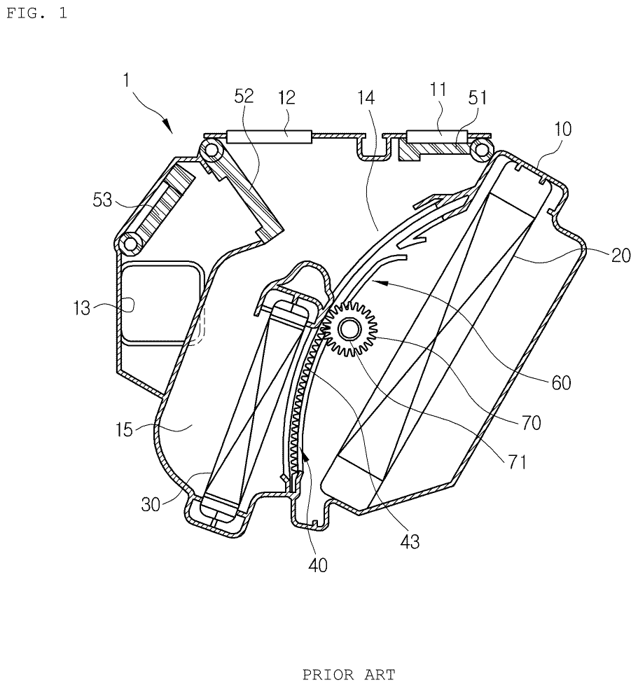

FIG. 2 is a side sectional view illustrating an air conditioner for a vehicle according to an embodiment of the present invention.

FIG. 3 is a perspective view illustrating a shaft of the air conditioner for the vehicle according to an embodiment of the present invention.

FIG. 4 is an exploded perspective views illustrating the interior of an air conditioning case having a shaft installed according to an embodiment of the present invention.

FIG. 5 is a cross-sectional view taken along line A-A of FIG. 3.

FIGS. 6 and 7 are perspective views of the shaft partially cut in a horizontal direction according to an embodiment of the present invention.

FIG. 8 is a cross-sectional view of the shaft cut in the horizontal direction according to an embodiment of the present invention.

FIG. 9 is a view of a vent mode of the air conditioner for a vehicle according to an embodiment of the present invention.

FIG. 10 is an enlarged view of the shaft in FIG. 9.

FIG. 11 illustrates a bi-level mode of the air conditioner for the vehicle according to an embodiment of the present invention.

FIG. 12 is an enlarged view of the shaft in FIG. 11.

FIG. 13 illustrates a defrost mode of the air conditioner for the vehicle according to an embodiment of the present invention.

FIG. 14 is an enlarged view of the shaft in FIG. 13.

### DETAILED DESCRIPTION OF THE PREFERRED EMBODIMENT

Hereinafter, referring to the drawings, the technical configuration of an air conditioner for a vehicle will be described in detail.

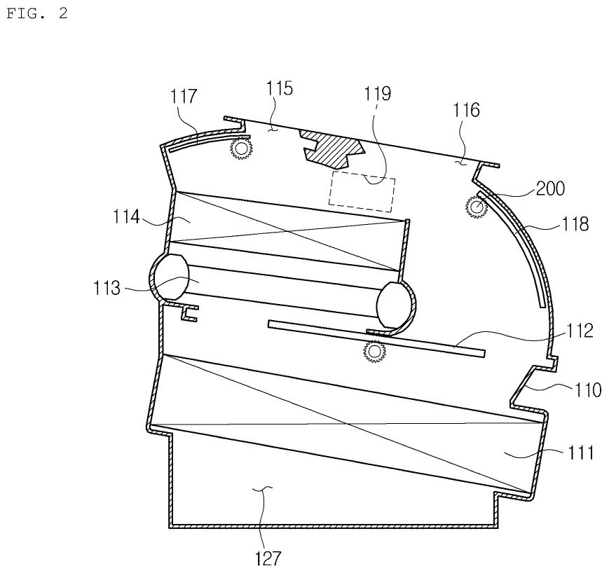

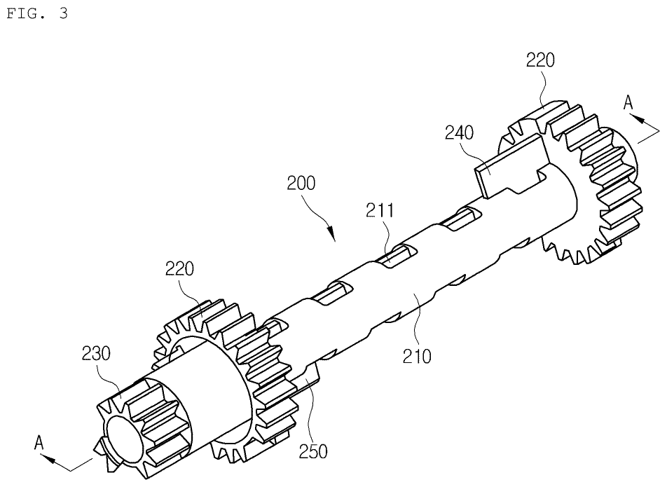

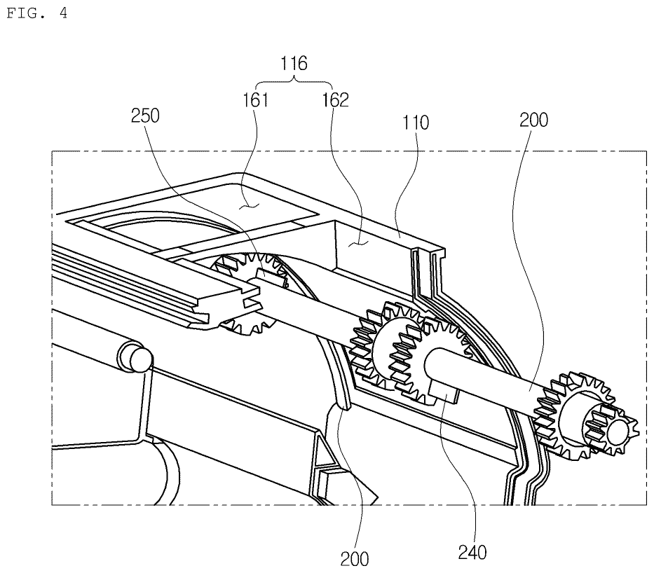

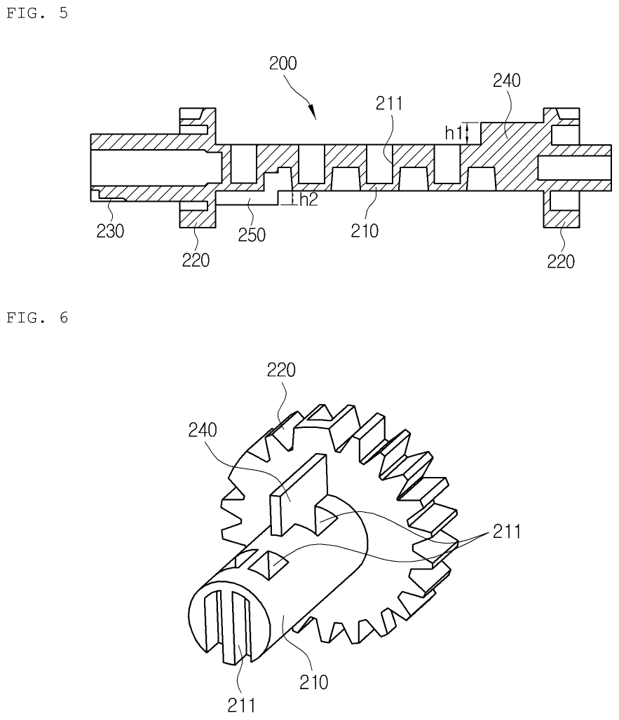

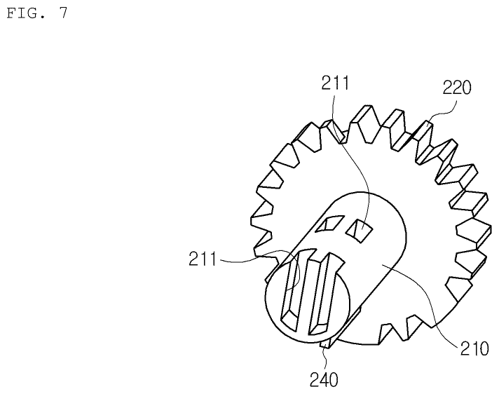

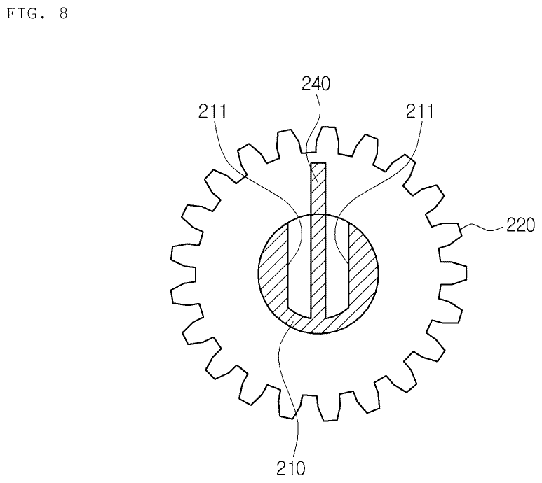

Referring to FIGS. 2 to 8, the air conditioner for a vehicle according to an embodiment of the present invention is a slim-type air conditioner with a horizontally arranged heat exchanger type, and has a relatively thin vertical width. The air conditioner for a vehicle according to an embodiment of the present invention includes an air conditioning case 110, a cooling heat exchanger, a heating heat exchanger. In the description below, the left-right direction in FIG. 2 corresponds to the vehicle's front-rear direction, while the left-right direction in FIG. 5 corresponds to the vehicle's width direction.

The air conditioning case 110 includes an air passage and is a slim type with a narrow vertical width. The air conditioning case 110 includes an air inflow port 127 and a plurality of air discharge ports. An air blower for blowing air into the air conditioning case 110 is connected to the air inflow port 127. The air blower selectively introduces inside air or outside air and blows the air into the air conditioning case 110.

Moreover, the air inflow port 127 is located below the cooling heat exchanger so that air flows from the bottom to the top. The air discharge ports of the air conditioning case 110 includes a defrost vent 115, a face vent 116, and a floor vent 119. The defrost vent 115 is formed to direct air toward the vehicle windows, the face vent 116 is formed to direct air toward the front seat passengers' faces, and the floor vent 119 is formed to direct air toward the front seat passengers' feet. The floor vent 119 is formed on the side of the air conditioning case 110 to guide air toward the lower portion of the vehicle through a duct.

The cooling heat exchanger is an evaporator 111, and the heating heat exchanger is an indoor condenser 113. An electric heater 114 such as a PTC heater is provided downstream of the indoor condenser 113 in the air flow direction. The evaporator 111 and the indoor condenser 113 are connected in a refrigerant circulation line connecting a compressor, an expansion valve, etc., to act as a cooling means or a heating means depending on the refrigerant state. That is, the refrigerant passing through the evaporator 111 exchanges heat with air to cool the air, and the refrigerant passing through the indoor condenser 113 exchanges heat to heat the air.

The evaporator 111 and the indoor condenser 113 are sequentially arranged in the air passage of the air conditioning case 110 in the air flow direction. The evaporator 111, the indoor condenser 113, and the electric heater 114 are all arranged horizontally. That is, the internal passage of the air conditioning case 110 is vertically oriented relative to the ground, directing the airflow route from the lower part to the upper part in the direction of gravity. In addition, the cooling heat exchanger and the heating heat exchanger on the internal passage are arranged sequentially from the bottom to the top in the direction of gravity corresponding to the air flow route.

As described above, the heat exchangers are arranged horizontally relative to the ground surface or inclined at a predetermined angle to be close to the horizontal. That is, air is introduced into the air inflow port 127 at the lower side of the air conditioning case 110 and flows upwards. From below, the evaporator 111, the indoor condenser 113, and the electric heater 114 are arranged in sequence.

The air conditioner for a vehicle includes a temperature door 112 and a plurality of doors. The temperature door 112 is placed between the evaporator 111 and the indoor condenser 113. The temperature door 112 controls the opening degree between the warm air passage passing through the indoor condenser 113 and the cold air passage bypassing the indoor condenser 113 to adjust the interior temperature of the vehicle. That is, the temperature door 112 adjusts the amount of air passing through or the amount of air bypassing the indoor condenser 113 and the electric heater 114 according to the position thereof.

The temperature door 112 is a plate door that slides horizontally within the air conditioning case 110, adjusting the opening degree between the cold air passage and the warm air passage. The sliding-type temperature door 112 helps reduce the height of the air conditioning case 110. The doors adjust the opening degree of the air discharge ports. The doors are provided to adjust the opening degree of the air discharge ports, and include a defrost door 117 for adjusting the opening degree of the defrost vent 115, a vent door 118 for adjusting the opening degree of the face vent 116, and a floor door for adjusting the opening degree of the floor vent 119.

A separator which divides the inside of the air conditioning case 110 into the left and right in a vehicle width direction is provided within the air conditioning case 110. The separator divides the air passage of the air conditioning case 110 into the left and right, enabling right and left independent air conditioning for the driver's seat and the front passenger's seat. The air passage inside the air conditioning case 110 is divided into a left passage and a right passage by the separator.

Meanwhile, the face vent 116 includes a center vent 162 and side vents 161 partitioned in the vehicle width direction. Specifically, the left passage divided by the separator is partitioned into the center vent 162 and the side vent 161 by a partition wall, and the right passage is also divided into the center vent 162 and the side vent 161 by a partition wall. Consequently, the center vent 162 is formed at the central portion in the vehicle width direction, and the side vents 161 are positioned on both sides.

In this instance, the door is actuated in a sliding type. The door includes a shaft 200, a gear part, and a plate part. The plate part engages with the gear part to open and close the air discharge port. Additionally, the door shaft 200 includes a guide part. The guide part functions to guide the airflow toward the air discharge port when the air moves in the same direction as the movement of the door. The guide part includes a baffle. The baffle is formed to protrude radially from the shaft.

In an embodiment of the present invention, the baffle is formed on the shaft 200 of the vent door 118. The baffle rotates integrally with the shaft 200 as the vent door 118 slides. Therefore, the position and angle of the baffle vary depending on the position of the vent door 118. When positioned perpendicularly to the air flow direction, the baffle acts as a wall which blocks the airflow and guides the air flow direction. When aligned parallel to the air flow direction, the baffle has minimal effect on the airflow.

The guide part is positioned between the plate part and the shaft or positioned on the opposite side of the plate part depending on the position of the shaft 200 to guide the airflow. That is, the guide part is located to guide the air during the air conditioning modes as needed, but is positioned parallel to the air flow direction not to obstruct the airflow during the air conditioning modes where the guide part is not necessary.

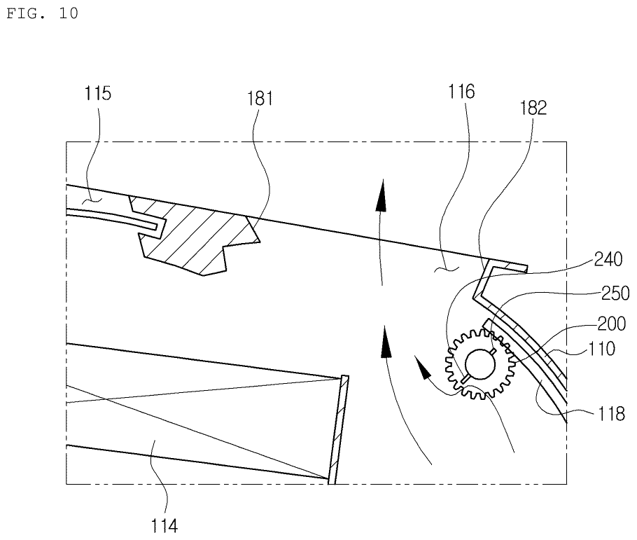

Additionally, the shaft 200 is placed on one side of the air discharge port. As illustrated in FIG. 10, the shaft 200 is located on one side of the face vent 116. That is, the shaft 200 is arranged outside an area between a starting end 182 and a terminating end 181 of the air discharge port. In this embodiment, the shaft 200 is installed on one side of the starting end 182 of the air discharge port. If the shaft 200 is positioned at the terminating end 181 or at the center of the air discharge port in the air flow direction, the guide part cannot perform the guiding function effectively. Thus, the shaft 200 is arranged at the starting end 182 of the air discharge port in the air flow direction.

The shaft 200 of the vent door 118 includes a cylindrical body part 210, and gear parts 220 formed on both sides of the body part 210. The gear parts 220 are located on both sides of the body part 210 in the longitudinal direction, which corresponds to the vehicle width direction. The gear parts 220 engage with gear teeth formed on the vent door 118. So, as the shaft 200 rotates, the vent door 118 slides. A driving gear 230, which is connected to a power source such as an actuator or power transmission means like arms and cams, is formed on one side of the body part 210.

The shaft 200 includes a plurality of recessed sliming parts 211. The sliming parts 211 are recessed inward on the outer circumferential surface of the body part 210, reducing the weight of the shaft 200 and improving the structural strength. The sliming parts 211 are alternately formed in a zigzag pattern on one side and the other side of the body part 210. In this case, the baffle is formed to protrude parallel to the recessed direction of the sliming parts 211. Therefore, the baffle can be formed integrally with the shaft since a mold can be took out at the time of injection-molding of the shaft 200.

Additionally, the protrusion length of the baffle is formed to be smaller than the radius of the gear part 220 of the shaft 200. Therefore, the baffle can rotate smoothly without interfering with the vent door 118 during the rotation of the shaft 200.

More specifically, the baffle includes a center vent baffle 240 and a side vent baffle 250. The center vent baffle 240 is positioned at a location corresponding to the center vent 162, and the side vent baffle 250 is positioned at a location corresponding to the side vent 161. The center vent baffle 240 serves as a means to increase resistance of air discharged to the center vent 162 and guide the airflow, whereas the side vent baffle 250 serves as a means to increase resistance of air discharged to the side vent 161 and guide the airflow.

As described above, since the center vent baffle 240 and the side vent baffle 250 are provided, the volume of air discharged to the center vent 162 and the side vent 161 can be appropriately controlled based on the installation environment of the air conditioner and passengers' preferences of air-conditioning.

The center vent baffle 240 and the side vent baffle 250 are arranged at different positions in the circumferential direction of the shaft 200. That is, the center vent baffle 240 and the side vent baffle 250 are positioned 180° apart from each other in the circumferential direction of the shaft 200 and protrude in opposite directions to each other. As described above, since the center vent baffle 240 and the side vent baffle 250 are arranged with 180° phase difference, during the movement of the vent door 118, air volumes of the center vent 162 and the side vent 161 can be controlled differently depending on the opening degree of the face vent 116.

The center vent baffle 240 and the side vent baffle 250 are formed only at a portion of an end of the shaft 200 in the axial direction. The center vent baffle 240 is formed only at a portion of the position corresponding to the center vent 162 in the vehicle width direction, and the side vent baffle 250 is formed only at a portion of the position corresponding to the side vent 161 in the vehicle width direction. Therefore, the center vent baffle 240 and the side vent baffle 250 can effectively reduce the air volumes of the center vent 162 and the side vent 161, guide the air flow direction, and prevent a decrease in overall airflow by not blocking the entire air passage.

Furthermore, the center vent baffle 240 protrudes further in the radial direction of the shaft 200 than the side vent baffle 250. As illustrated in FIG. 5, a protrusion height h1 of the center vent baffle 240 is greater than a protrusion height h2 of the side vent baffle 250. The center vent 162 is positioned at the center of the air conditioning case 110 in the vehicle width direction, so the airflow velocity through the center vent 162 is higher than that through the side vent 161. Thus, since the center vent baffle 240 protrudes further than the side vent baffle 250, the resistance of the air flowing to the center vent 162 is increased, thereby uniformly achieving the reduction in air volumes of the center vent 162 and the side vent 161 and the air flow direction guidance effect.

When the vent door 118 is in the air conditioning mode that opens the face vent 116, the baffle is arranged perpendicular to the air flow direction to suppress the flow of the air discharged through the face vent 116 and guide the air flow direction. That is, in the air conditioning modes where the face vent 116 is closed, the baffle is aligned parallel to the air flow direction, and acts as a wall only in the air conditioning mode where the face vent 116 is opened. So, the baffle has little effect on the airflow, preventing the deterioration in air conditioning performance.

Additionally, the center vent baffle 240 or the side vent baffle 250 is positioned to suppress the airflow depending on the air conditioning modes, selectively reducing the air volume to the center vent 162 or the side vent 161 and guiding the air flow direction. As described above, the baffle which is a structure obstructing the airflow within the air conditioning case 110 is attached to the shaft 200, thereby guiding the airflow in a desired direction. The baffle which acts as a resistor can suppress the airflow of the air discharge port (face vent) where excessive air volume is discharged and guide the air flow direction.

Thus, the air conditioner for the vehicle according to the present invention can use the disadvantage of the shaft 200 acting as a resistor, achieve a desired airflow by additionally installing a baffle as a resistor onto the shaft, improve the temperature controllability of cold air and warm air, and adjust the discharged airflow to enhance airflow distribution.

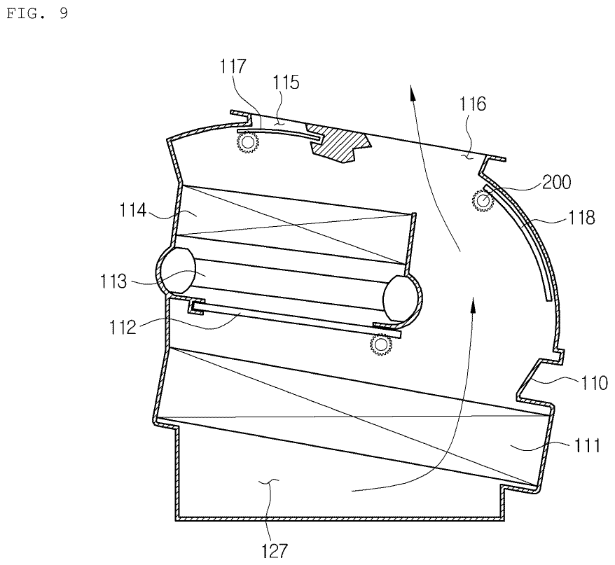

Referring to FIG. 9, in the vent mode, the air conditioner is controlled to discharge airflow only to the face vent 116. The defrost door 117 closes the defrost vent 115, and the floor door closes the floor vent 119. The vent door 118 fully opens the face vent 116. The temperature door 112 closes the warm air passage and opens the cold air passage, such that the air passing through the evaporator 111 bypasses the indoor condenser 113 and the electric heater 114 and is discharged to the face vent 116.

In this case, as illustrated in FIG. 10, the center vent baffle 240 is positioned to suppress the flow of air (cold air). The center vent baffle 240 partially blocks the airflow passing through the evaporator 111, reducing the amount of cold air discharged to the center vent 162 of the face vent 116 and guiding the air flow direction. In this instance, the side vent baffle 250 is positioned close to the vent door 118 and does not significantly affect the airflow. The above configuration can overcome the problem that the temperature of the air discharged to the center vent 162 becomes colder than that of the air discharged to the side vent 161 in the maximum vent mode.

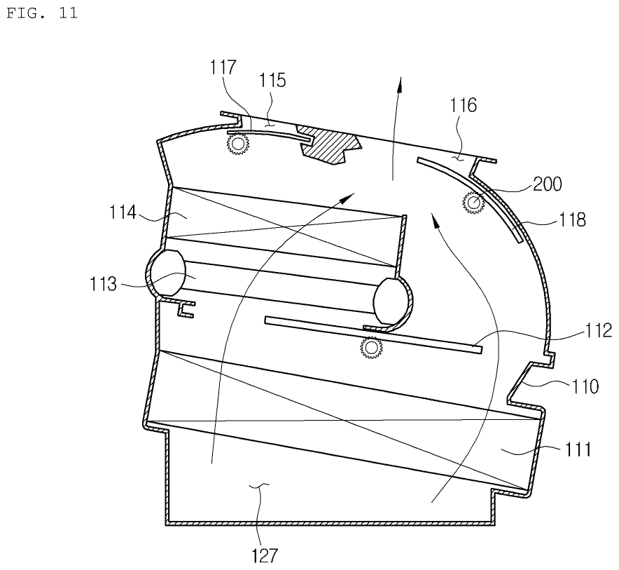

Additionally, referring to FIG. 11, in the bi-level mode, the air conditioner is controlled to discharge air to the face vent 116 and the floor vent 119. The defrost door 117 closes the defrost vent 115, and the floor door opens the floor vent 119. The vent door 118 opens the face vent 116. The temperature door 112 opens the warm air passage and the cold air passage such that a portion of the air passing through the evaporator 111 bypasses the indoor condenser 113 and the electric heater 114, and another portion of the air passes through the indoor condenser 113 and the electric heater 114.

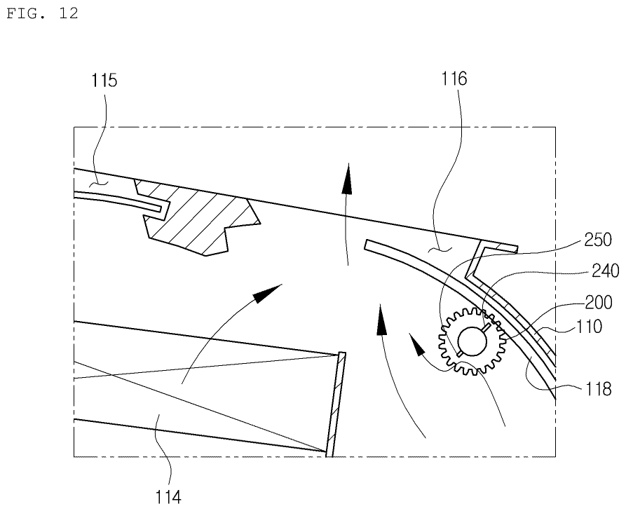

The cold air and the warm air are mixed in the mixing zone, and then, the mixed air is discharged to the face vent 116 and the floor vent 119. In this instance, as illustrated in FIG. 12, the side vent baffle 250 is positioned to suppress the flow of air (cold air). The side vent baffle 250 partially blocks the airflow passing through the evaporator 111, reducing the amount of the cold air discharged to the side vent 161 of the face vent 116 and guiding the air flow direction. In this instance, the center vent baffle 240 is positioned close to the vent door 118 and does not significantly affect the airflow. The above configuration can overcome the problem that the temperature of the air discharged to the side vent 161 becomes colder than that of the air discharged to the center vent 162 in the bi-level mode.

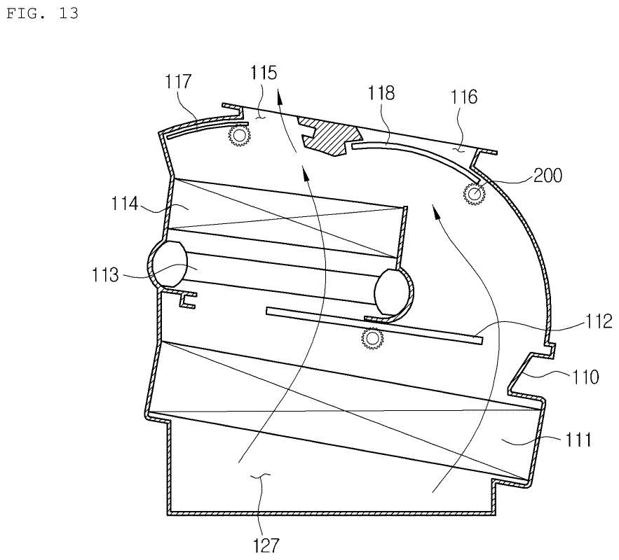

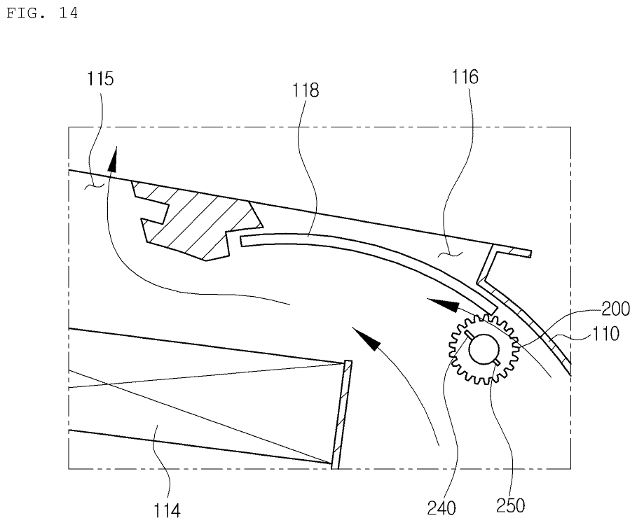

Furthermore, as illustrated in FIGS. 13 and 14, in a floor mode or the defrost mode, the center vent baffle 240 and the side vent baffle 250 are aligned parallel to the air flow direction. The floor mode is a mode to discharge air to the floor vent 119, and the defrost mode is a mode to discharge air to the defrost vent 115. As described above, in the air conditioning modes where the face vent 116 is closed, the center vent baffle 240 and the side vent baffle 250 are positioned parallel to the air flow direction, so have little impact on the airflow without functioning as a wall and a guide.

The air conditioner for a vehicle according to the present invention has been described with reference to the embodiments illustrated in the drawings, but the embodiments are merely examples. It should be apparent that modifications and variations can be made by persons skilled without deviating from the spirit or scope of the present invention. Therefore, the true scope of technical protection should be defined by the spirit of the appended claims.

What is claimed is:

1. An air conditioner for a vehicle comprising:
an air conditioning case in which an air passage and a plurality of air discharge ports are formed;
a cooling heat exchanger and a heating heat exchanger sequentially arranged in the air passage of the air conditioning case in an air flow direction; and
a door adjusting the opening degree of the air discharge ports,
wherein the door is formed in a sliding type and includes a shaft, a gear part, and a plate part which engages with the gear part to open and close the air discharge ports, and
wherein a guide part guiding the air flow direction is provided on the shaft.

2. The air conditioner according to claim 1, wherein the guide part is positioned between the plate part and the shaft or arranged on the opposite side of the plate part depending on the position of the shaft to guide the airflow.

3. The air conditioner according to claim 1, wherein the shaft is placed on one side of the air discharge port.

4. The air conditioner according to claim 2, wherein the guide part includes a baffle which protrudes on the shaft in a radial direction.

5. The air conditioner according to claim 4, wherein the baffle rotates integrally with the shaft as the door moves.

6. The air conditioner according to claim 5, wherein the door includes a vent door which adjusts the opening degree of a face vent, and
wherein the baffle is formed on the shaft of the vent door.

7. The air conditioner according to claim 6, wherein the face vent is partitioned into a center vent and a side vent in the vehicle width direction, and
wherein the baffle includes a center vent baffle formed at a position corresponding to the center vent and a side vent baffle formed at a position corresponding to the side vent.

8. The air conditioner according to claim 7, wherein the center vent baffle and the side vent baffle are positioned at different locations in the circumferential direction of the shaft.

9. The air conditioner according to claim 8, wherein the center vent baffle and the side vent baffle are positioned 180° apart from each other in the circumferential direction of the shaft, protruding in opposite directions to each other.

10. The air conditioner according to claim 7, wherein the center vent baffle and the side vent baffle are formed only on a portion of an end of the shaft in an axial direction.

11. The air conditioner according to claim 7, wherein the center vent baffle protrudes further in the radial direction of the shaft than the side vent baffle.

12. The air conditioner according to claim 6, wherein the shaft includes a plurality of recessed sliming parts, and
wherein the baffle protrudes parallel to the recessed direction of the sliming parts.

13. The air conditioner according to claim 6, wherein the baffle is positioned perpendicular to the air flow direction to suppress the flow of air discharged to the face vent during an air conditioning mode where the vent door opens the face vent.

14. The air conditioner according to claim 6, wherein the protrusion length of the baffle is formed to be smaller than the radius of the gear part of the shaft.

15. The air conditioner according to claim 7, wherein depending on the air conditioning mode, the center vent baffle or the side vent baffle is positioned to suppress the airflow, selectively reducing the airflow to the center vent or the side vent.

16. The air conditioner according to claim 7, wherein in a vent mode where air is discharged only to the face vent, the center vent baffle is positioned to suppress the airflow.

17. The air conditioner according to claim 7, wherein in a bi-level mode where air is discharged to the face vent and the floor vent, the side vent baffle is positioned to suppress the airflow.

18. The air conditioner according to claim 7, wherein in a floor mode where air is discharged to the floor vent or in a defrost mode where air is discharged to the defrost vent, the center vent baffle and the side vent baffle are positioned parallel to the air flow direction.
